(19) United States
(12) Patent Application Publication
(10) Pub. No.: US 2022/0204421 A1
(43) Pub. Date: Jun. 30, 2022

(54) PROCESS FOR MAKING A SEMI-SOLUBLE HUMIC GRANULE

(71) Applicant: Kevin Merritt, St. Augustine, FL (US)

(72) Inventor: Kevin Merritt, St. Augustine, FL (US)

(21) Appl. No.: 17/206,053

(22) Filed: Mar. 18, 2021

Related U.S. Application Data
(63) Continuation-in-part of application No. 16/210,646, filed on Dec. 5, 2018, now Pat. No. 11,117,840.
Application No. 16/210,646 is a continuation-in-part of application No. 15/878,773, filed on Jan. 24, 2018, now Pat. No. 10,597,337.
Application No. 15/878,773 is a continuation-in-part of application No. 14/738,865, filed on Jun. 13, 2015, now Pat. No. 9,914,670.
(60) Provisional application No. 62/013,789, filed on Jun. 18, 2014.

(51) Int. Cl. C05G 3/80; C05G 1/00; C05F 11/02

(52) U.S. Cl. CPC C05G 3/80; C05F 11/02; C05G 1/00

(57) ABSTRACT

A semi-soluble humate granule includes a homogenous powder mixture. The homogenous mixture includes a raw humate, a fully soluble humic acid enriched powder, a seaweed powder, a zinc sulfate powder, a sulfur sulfate powder, a magnesium sulfate powder, a manganese sulfate powder, a ferrous sulfate powder, a copper sulfate powder, a borate powder, and a sodium molybdate powder. The homogenous mixture is granulated to form the semi-soluble humate granule having a pH of about 3.5 to about 8.5.

### FIELD OF THE INVENTION

A process such as is described in various embodiments herein relates to a process for making a semi-soluble humic granule comprising humates, seaweed, various micronutrients, and/or other components. Such a granule is useful as an organic aid to crop growth.

### BACKGROUND OF THE INVENTION

Extraction of humic acid and related materials from carbonaceous raw materials (e.g. humalite, leonardite, sub-bituminous coal, menefee, peat, and/or the like) has been practiced for years and is accordingly known in the art. Process steps vary, but the process output is generally a particulate material with suboptimal solubility in water. Solubility in water may be desirable, as it allows for granules to dissolved into solution prior to application to the soil. Furthermore, organic and other producers typically prefer to apply mixtures including humates that are safe and healthful for both plants and workers, there is a need in the art for a process for making a semi-soluble humic granule for application to the soil.

### SUMMARY OF EMBODIMENTS

The herein-described embodiments address these and other problems associated with the art by providing a semi-soluble composite granule comprised of at least a fully-soluble humic acid powder and a rock phosphate powder, and a method of making the same. In some aspects, a semi-soluble humate granule includes a homogenous mixture. Such a homogenous mixture includes: raw humate comprising about 20% to about about 80% of the homogenous mixture; a fully soluble humic acid enriched powder comprising about 1% to about 30% of the homogenous mixture; a seaweed powder comprising about about 0.025% to about 5% of the homogenous mixture; a zinc sulfate powder comprising about 0.025% to about 5% of the homogenous mixture; a sulfur sulfate powder comprising about 0.025% to about 5% of the homogenous mixture; a magnesium sulfate powder comprising about 0.025% to about 5% of the homogenous mixture; a manganese sulfate powder comprising about 0.025% to about 5% of the homogenous mixture; a ferrous sulfate powder comprising about 0.025% to about 5% of the homogenous mixture; a copper sulfate powder comprising about 0.001% to about 2% of the homogenous mixture; a borate powder comprising about 0.001% to about 2% of the homogenous mixture; and a sodium molybdate powder comprising about 0.01% to about 1.0% of the homogenous mixture. This homogenous mixture is granulated to form the semi-soluble humate granule having a pH of about 3.5 to about 8.5.

In some embodiments, the homogenous mixture further includes a binder comprising about 0.25% to about 5% of the homogenous mixture. In some such embodiments, the binder is bentonite clay. In some embodiments, the seaweed powder is a sea kelp powder.

In some embodiments, the homogenous mixture further includes a rock phosphate powder comprising about 1% to about 50% of the homogenous mixture. In other embodiments, the homogenous mixture further includes a dormant microbial community composition powder. In some such embodiments, the dormant microbial composition powder includes at least one species selected from a group of genera consisting of: Acetobacter, Agrobacterium, Aquifex, Arthrobacter, Azoarcus, Azorhizobium, Azospirillum, Azotobacter, Bacillus, Beijerinckia, Burkholderia, Chlorobium, Chloroflexus, Chryseobacterium, Enterococcus, Escherichia, Flavobacterium, Flexibacter, Frankia, Gloeobacter, Gluconacetobacter, Halobacterium, Herbaspirillum, Lactobacillus, Leptonema, Mycobacterium, Paenibacillus, Phyllobacterium, Planctomyces, Pseudomonas, Rhizobia, Rhizobium, Rickettsia, Rhodocyclus, Sinorhizobium, Sphingomonas, Streptomyces, Synechococcus Thermotoga, Thermus, and Trichoderma.

In some embodiments, the raw humate comprises about 71.29% of the homogenous mixture; the fully soluble humic acid enriched powder comprises about 17% of the homogenous mixture; the seaweed powder is a sea kelp powder, and the sea kelp powder comprises about 2.0% of the homogenous mixture; the zinc sulfate powder comprises about 2.0% of the homogenous mixture; the sulfur sulfate powder comprises about 2.0% of the homogenous mixture; the magnesium sulfate powder comprises about 1.5% of the homogenous mixture; the manganese sulfate powder comprises about 1.5% of the homogenous mixture; the ferrous sulfate powder comprises about 1.0% of the homogenous mixture; a binder comprising a bentonite clay powder, the bentonite clay powder comprising about 1.0% of the homogenous mixture; the copper sulfate powder comprises about 0.5% of the homogenous mixture; the borate powder comprises about 0.2% of the homogenous mixture; and the sodium molybdate powder comprises about 0.01% of the homogenous mixture.

In some instances, the semi-soluble humate granule is between about 0.8 mm and about 4.0 mm in diameter. In other instances, the semi-soluble humate granule has a crush strength between about two psi and about eight psi.

In some embodiments, the semi-soluble humate granule is dosed at about 12 pounder per acre. In other embodiments, the semi-soluble humate granule is combined with a commercially available NPK fertilizer.

In another aspect, a semi-soluble humate granule includes a homogenous mixture, where the homogenous mixture includes: a raw humate comprising about 79.29% of the homogenous mixture; a fully soluble humic acid enriched powder comprising about 17% of the homogenous mixture; a sea kelp powder comprising about about 2.0% of the homogenous mixture; a zinc sulfate powder comprising about 2.0% of the homogenous mixture; a sulfur sulfate powder comprising 2.0% of the homogenous mixture; a magnesium sulfate powder comprising 1.5% of the homogenous mixture; a manganese sulfate powder comprising about 1.5% of the homogenous mixture; a ferrous sulfate powder comprising about 1.0% of the homogenous mixture; a bentonite clay powder comprising about 1.0% of the homogenous mixture; a copper sulfate powder comprising about 0.5% of the homogenous mixture; a borate powder comprising about 0.2% the homogenous mixture; a sodium molybdate powder comprising about 0.01% of the homogenous mixture; and where the homogenous mixture is granulated to form the semi-soluble humate granule having a pH of about 3.5 to about 8.5.

In some embodiments, the homogenous mixture additionally includes a rock phosphate powder. In other embodiments, the homogenous mixture additionally includes a dormant microbial community composition powder. In some such embodiments, the dormant microbial community composition powder includes at least one species selected from a group of genera consisting of: Acetobacter, Agrobacterium, Aquifex, Arthrobacter, Azoarcus, Azorhizobium, Azospirillum, Azotobacter, Bacillus, Beijerinckia, Burkholderia, Chlorobium, Chloroflexus, Chryseobacterium, Enterococcus, Escherichia, Flavobacterium, Flexibacter, Frankia, Gloeobacter, Gluconacetobacter, Halobacterium, Herbaspirillum, Lactobacillus, Leptonema, Mycobacterium, Paenibacillus, Phyllobacterium, Planctomyces, Pseudomonas, Rhizobia, Rhizobium, Rickettsia, Rhodocyclus, Sinorhizobium, Sphingomonas, Streptomyces, Synechococcus Thermotoga, Thermus, and Trichoderma.

In some embodiments, the semi-soluble humate granule is between about 0.8 mm and about 4.0 mm in diameter. In other embodiments, the semi-soluble humate granule has a crush strength between about two psi and about 8 psi.

In some embodiments, the semi-soluble humate granule is dosed at about 12 pounder per acre. In other embodiments, the semi-soluble humate granule is combined with a commercially available NPK fertilizer.

### BRIEF DESCRIPTION OF THE FIGURES

FIGS. 1A-D are photographic illustrations of an embodiment of semi-soluble granules described herein. FIG. 1A illustrates semi-soluble humate granules ranging from about 0.8 mm to about 1.0 mm in diameter disposed along a ruler for reference; FIG. 1B illustrates semi-soluble humate granules ranging from about 1.0 mm to about 1.4 mm in diameter disposed along a ruler for reference; FIG. 1C illustrates semi-soluble humate granules ranging from about 2.0 mm to about 2.8 mm in diameter disposed along a ruler for reference; FIG. 1D illustrates semi-soluble humate granules ranging from about 2.8 mm to about 4.0 mm in diameter disposed along a ruler for reference.

FIGS. 2A-B are photographic illustrations of the results of the crush strength testing of Example 1. FIG. 2A illustrates the results of the crush strength test for the granules screened as between less than 1 mm and 1.8 mm (e.g. 80 to 180 SGN). FIG. 2B illustrates the results of the crush strength test for the granules screened as between less than 2 mm and 4 mm (e.g. 200 to 400 SGN).

### DETAILED DESCRIPTION

A process and composition such as is described in various embodiments herein now will be described more fully hereinafter. A process such as is described in various embodiments herein may, however, be embodied in many different forms and should not be construed as limited to the embodiments set forth herein; rather, these embodiments are provided so that this disclosure will be thorough and complete, and will fully convey the scope of a process such as is described in various embodiments herein to those skilled in the art. As used in this specification and the claims, the singular forms “a,” “an,” and “the” include plural referents unless the context clearly dictates otherwise. When used in this specification and the claims as an adverb rather than a preposition, “about” means “approximately” and comprises the stated value and every value within 10% of that value; in other words, “about 100%” includes 90% and 110% and every value in between.

When used in this specification and the claims, a “semi-soluble granule” refers to a granule that partially dissolves in water under typical conditions of use (e.g. during irrigation, rainy conditions, etc.).

When used in this specification and the claims, a product is “enriched in humic acid” if the product possesses a higher concentration of humic acid than a raw material from which the product is made. A component becomes “enriched in humic acid” as the concentration of humic acid in the component increases. A component becomes “depleted of humic acid” as the concentration of humic acid in the component decreases.

When used in this specification and the claims, a “carbonaceous substance comprising humic acid and one or more other substances” refers to a carbonaceous substance that contains humic acid and that also contains one or more other substances other than humic acid. An example is humalite. An example is lignite. An example is leonardite.

When used in this specification and the claims, a “dormant” microbial organism refers to a period in a microbial organism's life cycle when metabolic activity is temporarily slowed. Microbial organisms may enter a dormant state when stressful conditions are encountered, such as exposure to the cold, nutrient depletion or starvation, or the like. Dormancy is a reversible state, from which a microbial organism can exit and return to its typical metabolic activity. As a non-limiting example, some organisms (e.g. members of the genus Bacillus) may form (or be induced to form) endospores when entering a dormant state. Endospores are tough, non-reproductive, structures produced by a bacterium that function to aid the organism's survival. In some instances, endospores may be resistant to ultraviolet radiation, lysosomes, extreme temperatures, nutrient depletion, and/or chemical disinfectants. As a further non-limiting example, organisms may be induced into a dormant state through lyophilization. Lyophilization is the process of freeze-dying microbial organisms, which includes culturing the desired microorganism, suspending the culture in an appropriate lyophilization medium or buffer, and subjecting the suspended culture to a lyophilization process. Lyophilized microorganisms may then be rehydrated at a desired time.

In an example, production of a semi-soluble humate granule comprising seaweed micronutrients, etc. may be undertaken as a multi-step process. The first general step comprises blending a raw carbonaceous substance comprising humic acid and one or more other substances and an alkaline mixture in a blend tank; screening the blended mixture that was made in the blend tank; drying the liquid derived from screening of the blended mixture, thereby forming a fully soluble fine powder of enriched, hydrolyzed humic acid. This fully soluble hydrolyzed humic acid enriched powder, and the process for making the same, are discussed in detail in U.S. Pat. Nos. 9,914,670 and 10,723,667, each incorporated herein by reference in their entirety. In a second general step, this hydrolyzed humic acid enriched powder is combined with a raw humate, seaweed, and/or various micronutrients; this combined powder is then processed to form granules.

For example, the fully soluble hydrolyzed humic enriched powder may generate organo-clay minerals, covalent bonds, ion exchanges, coordinate bonds, hydrophobic reactions, ligand exchanges, adsorption bonding, and so on when applied to the soil, which may enhance the overall crop production. In some instances, the fully soluble hydrolyzed humic enriched powder may comprise between about 1% to about 30% of the final semi-soluble humate granule. In addition to the fully soluble hydrolyzed humic enriched powder the semi-soluble humate granule may further include raw humate. The terms “humic substances” or “raw humates” may refer to the combined components of humic, fulvic, and humin in their raw, newly extracted, and chemically unaltered form. This raw humate, which may be generally insoluble, may be found concentrations ranging between 0.025% to 10% in various soils. These raw humate are generally amorphous, hydrophilic, possess acid forming abilities, and are widely dispersed with various molecular weights. In some instances, the raw humate may comprise between about 20% to about 80% of the final semi-soluble humate granule.

As is known, different crops have differing nutritional needs, and may require various biochemical processes to overcome abiotic stressors. As described in detail herein, seaweed may be used as a part of the final granule to enhance plant health. Sea kelp, for example, may include high levels of cytokines that may promote cell division, root, and shoot growth, enhance photosynthesis, and improve plant health. Seaweed (e.g. sea kelp) may, in particular, be beneficial for reducing the impacts of salinity. Seaweed, which may in some instances be in the specific form of sea kelp, may comprise between about 0.025% to about 5% of the final semi-soluble humate granule. Furthermore, sulfur may also play an important role in soil health and chemistry. Among its various effects, sulfur may have a role in: stabilizing nitrogen; balancing nitrogen/sulfur ratios for protein synthesis; lowering soil pH; producing lignin and pectin; producing chlorophyll; and assisting in nodular formation of sugars and starches. Sulfur sulfate may comprise between about 0.025% to about 5% of the final semi-soluble humate granule.

Various other micronutrients are also important to plant growth, as will be discussed in detail herein, different micronutrients possessing different chemical, physical, and biological functionalities to improve plant growth. For example, zinc may facilitate uniform maturity, calcium translocation, and may be important for synthesis of proteins and auxins; furthermore, since zinc may be an essential component of many metabolic reactions in plants, zinc may be a micronutrient necessary to for plants to grow efficiently. Because of its solubility in water, zinc sulfate may be used as a source of zinc in the resulting semi-soluble humate granule described herein. Zinc sulfate may comprise between about 0.025% to about 5% of the final semi-soluble humate granule. In another example, manganese, which may in some instances be in the form of manganese sulfate, may be important for nitrogen utilization and assimilation. Manganese sulfate may comprise between about 0.025% to about 5% of the final semi-soluble humate granule. Iron may be important for respiration and enzyme activation. Iron, in the form of ferrous sulfate, may comprise between about 0.025% to about 5% of the final semi-soluble humate granule. Copper, which may in some instances be in the form of copper sulfate, is also an important micronutrient as it may be important for seed development and enzymatic activities. Copper sulfate may comprise between about 0.001% to about 2% of the final semi-soluble humate granule. In some instances, boron may also be included in the micronutrients, for example in the form of borates or boron-oxygen compounds. Boron may be important in cell wall formation and stability, as well as maintaining structural and functional integrity of a plant's biological membranes. Boron, in the form of borate, may comprise between about 0.001% to about 2% of the final semi-soluble humate granule. Magnesium, for example in the form of magnesium sulfate, may also, in some instances, be included in the micronutrients. Magnesium is important in photosynthesis, and a deficiency may result altered leaf coloration in some plants. Magnesium sulfate may comprise between about 0.025% to about 5% of the final semi-soluble humate granule. Finally, molybdenum, in the form of sodium molybdate, may also be included, in some instances. Molybdenum may be important to plants as it is an essential component in two enzymes involved in converting nitrate into nitrite and then into ammonia, prior to the ammonia being used to synthesize amino acids within the plant. Sodium molybdate may comprise between about 0.01% to about 1.0% of the final semi-soluble humate granule.

It is to be understood that the micronutrients described herein (e.g. iron, manganese, magnesium, zinc, copper, boron, molybdenum, etc.) may be used in any number of chemical forms. The micronutrients are not limited to the forms presented herein (e.g. sulfates).

In an example, the fully soluble fine humic acid enriched powder may be homogenized with with a raw humate, seaweed, and/or various micronutrients. In some instances, a ribbon blender, double cone blender, or other such blending apparatus, may be used for such a time so as to obtain a homogenous blend of fully soluble humic acid enriched powder, raw humate, seaweed, and various micronutrients. In some instances, this mixture may further include a binder. Some, non-limiting examples, of types of binders that may be used include, but are not limited to, bentonite clay, calcium lignosulphonate, other lignosulphates, and/or one or more polysaccharide sugars (e.g. Rantec™ RX2000). The binder, if used and regardless of the particular binder selected, may comprise between about 0.25% to about 5% of the final semi-soluble humate granule.

In another example, the fully soluble hydrolyzed humic acid enriched powder is first blended with the sea kelp and various micronutrients (e.g. sulfur sulfate, zinc sulfate, manganese sulfate, ferrous sulfate, copper sulfate, borate, magnesium sulfate, sodium molybdate), and other optional components (e.g. binder, rock phosphate, microbial community composition, etc.) with a ribbon blender. Once these components are homogenized into a mixture, the hydrolyzed humic acid enriched powder/sea kelp/micronutrient mixture may be further blended with the raw humate using a double cone blender; this second blending (with the double cone blender) may result in the final homogeneous mixture utilized to form the semi-soluble humate granules. This final homogenous mixture, may in some instances, have a moisture content of about 5% to about 25%.

Regardless of blending process used, the conversion of this homogenous mixture into a semi-soluble granule may be affected by an apparatus comprising a mechanical roller compactor. In some instances, the roller compactor further includes pocket rollers, which may operate at a rotation speed of 8-30 rpm. In other instances, the pressure exerted on the roller compacter may is about 1,500-3,000 psi. In still other instances, the temperature during the compaction, for example by the roller compactor, does not exceed about 130 degrees Fahrenheit.

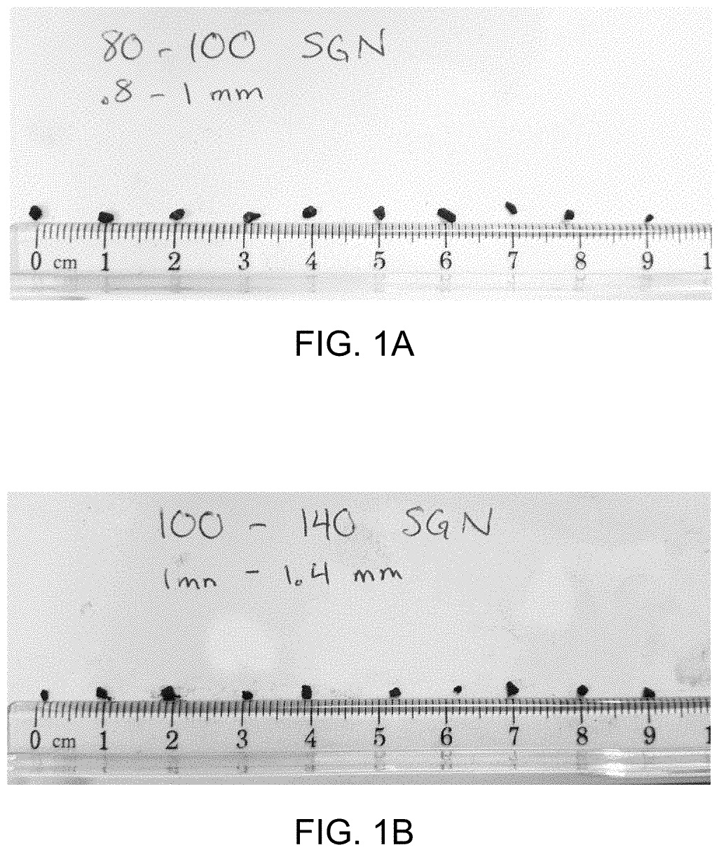

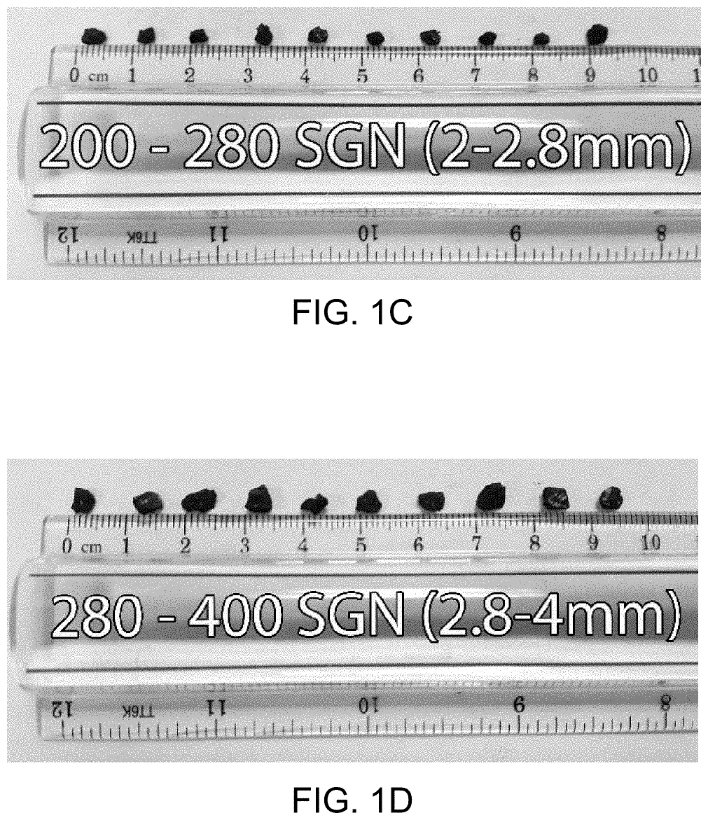

The compacted semi-soluble granules may then be blown out pneumatically and screened by means of a vibratory screener to achieve relative uniformity of size distribution, which may in some instances be between about 0.8 mm and about 4.0 mm. Various exemplary sizes of semi-soluble humate granules are illustrated in FIGS. 1A-D. In FIG. 1A, the semi-soluble humate granules are about 0.8 mm to about 1.0 mm in size; in FIG. 1B, the semi-soluble humate granules are about 1.0 mm to about 1.4 mm in size; FIG. 1C, the semi-soluble humate granules are about 2.0 mm to about 2.8 mm in size; FIG. 1D, the semi-soluble humate granules are about 2.8 mm to about 4.0 mm in size. The sizes illustrated in FIGS. 1-D are to be understood as merely exemplary, and are not intended to be limiting. Furthermore, as a non-limiting example, semi-soluble humate granules of that are about 2.0 mm-4.0 mm in size may be used for various agricultural uses, while granules that are about 0.8 mm-2.0 mm may be used for horticultural uses. These final semi-soluble humate granule may, in some instances, have a moisture content of about 5% to about 25%. The final semi-soluble humate granule may also, in some instances, have a pH between about 3.5 and about 8.5. Resulting composite granules allow for easy transport, as well as application in dry farming systems. Furthermore, the resulting granules are semi-soluble, meaning they may partially dissolve in water (e.g. irrigation and/or rainwater (for example in dry farming applications) and have been found to aid plant growth in both agricultural and horticultural applications.

Furthermore, in some embodiments, the homogeneous mixture may additionally include a rock phosphorous powder. The rock phosphate powder may comprise about 0% to about 50% of the homogeneous mixture. In some instances, the rock phosphate powder may comprise: about 15% to about 30% phosphorus pentoxide; about 30% to about 60% calcium carbonate; and about 10% to about 20% silica.

In other embodiments, the homogeneous mixture may further includes a dormant microbial community composition powder comprising about 0.0025% to about 5% of the homogenous mixture. In some such embodiments, the dormant microbial community composition powder may include at least one methylotrophic microbial species. In other such embodiments, the plurality of dormant microbial organisms may include at least one species selected from the group of genera consisting of: Acetobacter, Agrobacterium, Aquifex, Arthrobacter, Azoarcus, Azorhizobium, Azospirillum, Azotobacter, Bacillus, Beijerinckia, Burkholderia, Chlorobium, Chloroflexus, Chryseobacterium, Enterococcus, Escherichia, Flavobacterium, Flexibacter, Frankia, Gloeobacter, Gluconacetobacter, Halobacterium, Herbaspirillum, Lactobacillus, Leptonema, Mycobacterium, Paenibacillus, Phyllobacterium, Planctomyces, Pseudomonas, Rhizobia, Rhizobium, Rickettsia, Rhodocyclus, Sinorhizobium, Sphingomonas, Streptomyces, Synechococcus Thermotoga, Thermus, and Trichoderma. In still other such embodiments, the dormant microbial community composition powder may include at least one Bacillus megaterium, Bacillus linchenformis, Bacillus amyloliquefaciens, Bacillus methylotrophicus, Bacillus pumilus, Pseudomonas flourescens, Pseudomonas putida, Pseudomonas striata, and/or Pseudomonas aeruginosa. In some such embodiments, the microbial community composition powder may include a lyophilized microbial powder.

The specific microbial community composition may vary based on the end use of the granule. As a non-limiting example, in some instances in may be desirable to include microbial organisms capable of nitrogen fixation. While, in other instances, it may be desirable to include microbial organisms capable of solubilizing phosphate. In still other instances, in may be desirable to include organisms capable of bioremediation of the soil. As such, in some circumstances, a commercially available dormant microbial community composition powder may be used; while, in other circumstances, it may be desirable to custom tailor the microbial community composition to the desired end use of the granule. As discussed previously, lyophilization may be used to in order to induce dormancy in the microbial community, microbial community compositions may be lyophilized through use of a shelf lyophilized, a manifold, or any other method of lyophilization known in the art.

Once formed, granules may be packaged and stored. In some instances, it may be preferable to store the semi-soluble humate granules in a dry location. Once obtained by an end user, the semi-soluble humate granules may be, in some instances, combined with other products. As a non-limiting example, the semi-soluble humate granules may be combined with a commercially available dry nitrogen-phosphorus-potassium (NPK) fertilizer. Either in combination with the commercially available NPK fertilizer, or alone, the semi-soluble humate granules may be placed directly on the ground, for example in furrow or in a trench. As a non-limiting example, the semi-solid granule may be dosed at about 5 pounds to about 25 pounds per acre. Once the granules get wet (through, for example, irrigation, rain fall, or the like) the granule may partially dissolve. For example, the humic acid enriched powder portion of the granule may dissolve, while the raw humate and other portions of the granule may remain solid.

### EXAMPLES

### Example 1

A homogenized mixture was generated by combining a fully soluble hydrolyzed humic acid enriched powder, a raw humate, sea kelp, and various micronutrients as outlined in Table 1 below. A ton (2,000 pound) mixture was created according to the percentages/amounts outlined in Table 1.

| | Percentage | Amount |
|---|---|---|
| Component | of Mixture | (lbs) |
| Raw Humate | 71.29% | 1,425.8 |
| Fully Soluble Humic Acid Enriched Powder | 17% | 340 |
| (Humi[K] WSP ™) | | |
| Sea Kelp Powder | 2.0% | 40 |
| Zinc Sulfate | 2.0% | 40 |
| Sulfur Sulfate | 2.0% | 40 |
| Magnesium Sulfate | 1.5% | 30 |
| Manganese Sulfate | 1.5% | 30 |
| Ferrous Sulfate | 1.0% | 20 |
| Bentonite Clay | 1.0% | 20 |
| Copper Sulfate | 0.5% | 10 |
| Borate | 0.2% | 4.0 |
| Sodium Molybdate | 0.01% | 0.2 |

Once mixed, the homogenous composition was granulated via a roller compactor with pocket rollers operating at a rotation speed of 8 rpm, with a pressure of about 1700 psi. Once granulated, the semi-soluble humate granule was applied to soil at a dosing of 12 lbs. per acre.

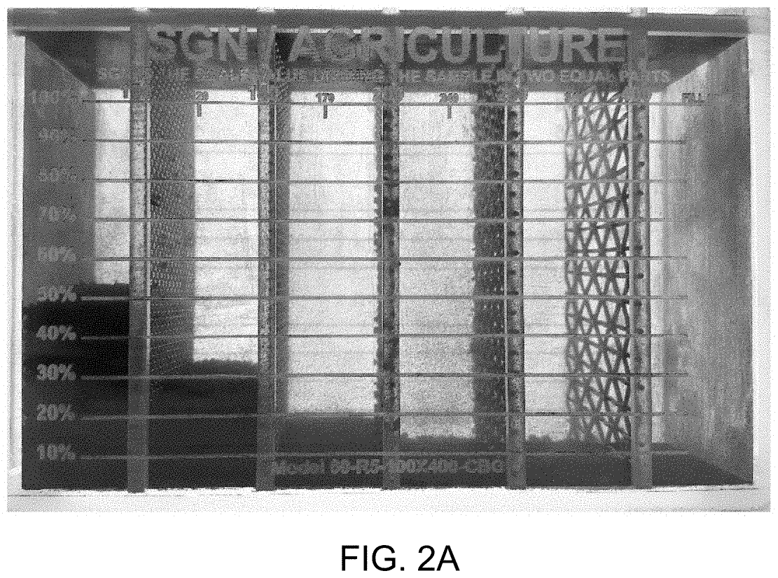

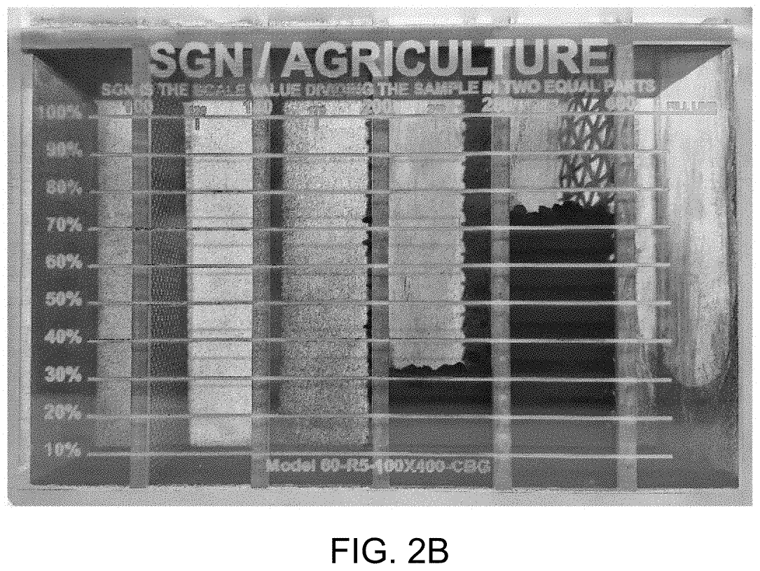

The final granule had a pH of about 5. Although, as discussed herein the pH may, in some instances, range from between about 3.5 and about 8.5. The resulting semi-soluble humate granules were subjected to crush strength testing. This testing, which test hardness of the granules, uses a sieve vibrating screener with one inch steel balls for four minutes. The results of the crush strength testing for the granules screened as between less than 1 mm and 1.8 mm (e.g. 80 to 180 SGN) are presented below in Table 1 and in FIG. 2A. The average crush strength of the granules sized less than 1 mm to 1.8 mm was 0.378. The results of the crush strength testing for the granules screened as between less than 2 mm and 4 mm (e.g. 200 to 400 SGN) are presented below in Table 2 and in FIG. 2B. The average crush strength of the granules sized less than 1 mm to 1.8 mm was 3.8.

TABLE 1

| SGN | % Vol. | Avg. SGN | CT 1 | CT 2 | CT 3 | CT 4 | CT 5 | CT 6 | CT 7 | CT 8 | CT 9 | CT 10 | Avg. |
|---|---|---|---|---|---|---|---|---|---|---|---|---|---|
| 280-340-400 | 0 | 110 | — | — | — | — | — | — | — | — | — | — | — |
| 200-240-280 | 0 | | — | — | — | — | — | — | — | — | — | — | — |
| 140-170-200 | 20 | | 0.0 | 0.25 | 0.1 | 0.1 | 0 | 3 | 0.25 | 0 | 0.5 | 0.45 | 0.465 |
| 100-120-140 | 30 | | 0.1 | 0.5 | 0.25 | 0.3 | 1 | 2 | 1.25 | 0.1 | 1 | 0.5 | 0.7 |
| 60-80-100 | 50 | | 0.25 | 0.15 | 0.15 | 0.25 | 0 | 0 | 0.1 | 0.2 | 0.2 | 0.2 | 0.15 |

TABLE 2

| SGN | % Vol. | Avg. SGN | CT 1 | CT 2 | CT 3 | CT 4 | CT 5 | CT 6 | CT 7 | CT 8 | CT 9 | CT 10 | Avg. |
|---|---|---|---|---|---|---|---|---|---|---|---|---|---|
| 280-340-400 | 75% | 339 | 1 | 4.5 | 8 | 2.5 | 6.5 | 3 | 3.5 | 3 | 6 | 5 | 4.3 |
| 200-240-280 | 30% | | 3.5 | 2 | 2.5 | 2.5 | 1.5 | 0 | 0 | 0 | 3.5 | 1 | 1.65 |
| 140-170-200 | 0 | | — | — | — | — | — | — | — | — | — | — | — |
| 100-120-140 | 0 | | — | — | — | — | — | — | — | — | — | — | — |
| 60-80-100 | 0 | | — | — | — | — | — | — | — | — | — | — | — |

The resulting crush strength of the granules is between about 0.38 psi and about 8 psi. However, it is to be understood that this example is for illustrative purposes only and are non-limiting, in some instances the crush strength of a composite granule consistent with the description herein may range anywhere from 0.1 psi to 10 psi.

Many modifications and other embodiments of a process such as is described in various embodiments herein will come to mind to one skilled in the art to which this disclosed process pertains having the benefit of the teachings presented in the foregoing description. Therefore, it is to be understood that a process such as is described in various embodiments herein is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. A semi-soluble humate granule comprising:
a homogenous mixture comprising:
a raw humate comprising about 20% to about about 80% of the homogenous mixture;
a fully soluble humic acid enriched powder comprising about 1% to about 30% of the homogenous mixture;
a seaweed powder comprising about about 0.025% to about 5% of the homogenous mixture;
a zinc sulfate powder comprising about 0.025% to about 5% of the homogenous mixture;
a sulfur sulfate powder comprising about 0.025% to about 5% of the homogenous mixture;
a magnesium sulfate powder comprising about 0.025% to about 5% of the homogenous mixture;
a manganese sulfate powder comprising about 0.025% to about 5% of the homogenous mixture;
a ferrous sulfate powder comprising about 0.025% to about 5% of the homogenous mixture;
a copper sulfate powder comprising about 0.001% to about 2% of the homogenous mixture;
a borate powder comprising about 0.001% to about 2% of the homogenous mixture;
a sodium molybdate powder comprising about 0.01% to about 1.0% of the homogenous mixture; and
wherein the homogenous mixture is granulated to form the semi-soluble humate granule having a pH of about 3.5 to about 8.5.

2. The semi-soluble humate granule of claim 1, wherein the homogenous mixture further comprises a binder comprising about 0.25% to about 5% of the homogenous mixture.

3. The semi-soluble humate granule of claim 2, wherein the binder is bentonite clay.

4. The semi-soluble humate granule of claim 1, wherein the seaweed powder is a sea kelp powder.

5. The semi-soluble humate granule of claim 1, wherein the homogenous mixture further comprises a rock phosphate powder comprising about 1% to about 50% of the homogenous mixture.

6. The semi-soluble humate granule of claim 1, wherein the homogenous mixture further comprises a dormant microbial community composition powder.

7. The semi-soluble humate granule of claim 6, wherein the dormant microbial community composition powder includes at least one species selected from a group of genera consisting of: Acetobacter, Agrobacterium, Aquifex, Arthrobacter, Azoarcus, Azorhizobium, Azospirillum, Azotobacter, Bacillus, Beijerinckia, Burkholderia, Chlorobium, Chloroflexus, Chryseobacterium, Enterococcus, Escherichia, Flavobacterium, Flexibacter, Frankia, Gloeobacter, Gluconacetobacter, Halobacterium, Herbaspirillum, Lactobacillus, Leptonema, Mycobacterium, Paenibacillus, Phyllobacterium, Planctomyces, Pseudomonas, Rhizobia, Rhizobium, Rickettsia, Rhodocyclus, Sinorhizobium, Sphingomonas, Streptomyces, Synechococcus Thermotoga, Thermus, and Trichoderma.

8. The semi-soluble humate granule of claim 1, wherein:
the raw humate comprises about 71.29% of the homogenous mixture;
the fully soluble humic acid enriched powder comprises about 17% of the homogenous mixture;
the seaweed powder is a sea kelp powder, and the sea kelp powder comprises about 2.0% of the homogenous mixture;
the zinc sulfate powder comprises about 2.0% of the homogenous mixture;
the sulfur sulfate powder comprises about 2.0% of the homogenous mixture;
the magnesium sulfate powder comprises about 1.5% of the homogenous mixture;
the manganese sulfate powder comprises about 1.5% of the homogenous mixture;
the ferrous sulfate powder comprises about 1.0% of the homogenous mixture;
a binder comprising a bentonite clay powder, wherein the bentonite clay powder comprises about 1.0% of the homogenous mixture;
the copper sulfate powder comprises about 0.5% of the homogenous mixture;
the borate powder comprises about 0.2% of the homogenous mixture; and
the sodium molybdate powder comprises about 0.01% of the homogenous mixture.

9. The semi-soluble humate granule of claim 1, wherein the semi-soluble humate granule is between about 0.8 mm and about 4.0 mm in diameter.

10. The semi-soluble humate granule of claim 1, wherein the semi-soluble humate granule has a crush strength between about two psi and about 8 psi.

11. The semi-soluble humate granule of claim 1, wherein the semi-soluble humate granule is dosed at about 12 pounds per acre.

12. The semi-soluble humate granule of claim 1, wherein the semi-soluble humate granule is combined with a commercially available NPK fertilizer.

13. A semi-soluble humate granule comprising:
a homogenous mixture comprising:
a raw humate comprising about 79.29% of the homogenous mixture;
a fully soluble humic acid enriched powder comprising about 17% of the homogenous mixture;
a sea kelp powder comprising about about 2.0% of the homogenous mixture;
a zinc sulfate powder comprising about 2.0% of the homogenous mixture;
a sulfur sulfate powder comprising 2.0% of the homogenous mixture;
a magnesium sulfate powder comprising 1.5% of the homogenous mixture;
a manganese sulfate powder comprising about 1.5% of the homogenous mixture;
a ferrous sulfate powder comprising about 1.0% of the homogenous mixture;
a bentonite clay powder comprising about 1.0% of the homogenous mixture;
a copper sulfate powder comprising about 0.5% of the homogenous mixture;
a borate powder comprising about 0.2% the homogenous mixture;
a sodium molybdate powder comprising about 0.01% of the homogenous mixture; and
wherein the homogenous mixture is granulated to form the semi-soluble humate granule having a pH of about 3.5 to about 8.5.

14. The semi-soluble humate granule of claim 13, wherein the semi-soluble humate granule is between about 0.8 mm and about 4.0 mm in diameter.

15. The semi-soluble humate granule of claim 13, wherein the semi-soluble humate granule has a crush strength between about two psi and about 8 psi.

16. The semi-soluble humate granule of claim 13, wherein the semi-soluble humate granule is dosed at about 5 pounds to about 25 pounds per acre.

17. The semi-soluble humate granule of claim 16, wherein the semi-soluble humate granule is dosed at about 12 pounds per acre

18. The semi-soluble humate granule of claim 13, wherein the semi-soluble humate granule is combined with a commercially available NPK fertilizer.
